(19) United States
(12) Patent Application Publication
(10) Pub. No.: US 2005/0228659 A1
(43) Pub. Date: Oct. 13, 2005

(54) Stealth communication method

(76) Inventor: Vlad Mitlin, San Diego, CA (US)

Correspondence Address: Vlad Mitlin, 10329 Azuaga St 263, San Diego, CA, 92129, US

(21) Appl. No.: 10/817,869

(22) Filed: Apr. 6, 2004

(51) Int. Cl. G10L 21/02

(52) U.S. Cl. 704/226

(57) ABSTRACT

In accordance with the present invention, there is provided a stealth communication method for transmitting a proprietary message using an information-bearing noise having an internal structure associated with the message. The spectral properties of the information-bearing noise are indistinguishable from those of the noise in the communication channel. This information-bearing noise can be combined with a non-random decoy signal.

### FIELD OF THE INVENTION

The present invention relates to proprietary data transmission and, more particularly, to transmitting and receiving a proprietary message using an information-bearing noise having an internal structure associated with the message.

### BACKGROUND OF THE INVENTION

Methods of transmitting proprietary data are in demand for both civil and military applications. Transmitting proprietary data is a challenging problem for the following reasons. On the one hand, proprietary data should not be easily retrieved by an enemy (in military applications) or by a competitor (in business applications) if the data were intercepted. On the other hand, proprietary data should be successfully retrieved by their intended recipient.

A traditional approach to transmitting~proprietary data consists in encoding a given proprietary message in a non-random signal and then hiding that signal in a noise-like background. However, since the signal used for encoding is not random, it will be retrieved by an enemy or a competitor as soon as they are able to recognize the presence of a useful signal in the noisy background and to separate this signal from the noise. It would be very useful to introduce a proprietary data transmission technique which is free of this drawback.

### SUMMARY OF THE INVENTION

In accordance with the present invention, there is provided a stealth communication method for transmitting a proprietary message using an information-bearing noise having an internal structure associated with the message. The spectral properties of the information-bearing noise are indistinguishable from those of the noise in the communication channel. This information-bearing noise can be combined with a non-random decoy signal.

### BRIEF DESCRIPTION OF THE DRAWINGS

A complete understanding of the present invention may be obtained by reference to the accompanying drawings, when considered in conjunction with the subsequent, detailed description, in which:

FIG. 1 is an outline of the preferred embodiment of the invention.

FIG. 2 is a view of the spectrum of the sparse component of the smart noise.

FIG. 3 is a view of the spectrum of the dense component of the smart noise.

FIG. 4 is a view of the spectrum of the smart noise.

FIG. 5 is a snapshot of the smart noise.

FIG. 6 is a view of the spectrum of a mixture of the smart noise and the channel noise.

FIG. 7 is a view of the spectrum of a mixture of the smart noise and the channel noise.

FIG. 8 is a view of the spectrum of a mixture of the smart noise and the channel noise.

FIG. 9 is a snapshot of a pure channel noise integrated over time.

FIG. 10 is a snapshot of a mixture of the smart noise and the channel noise integrated over time.

FIG. 11 is a snapshot of a mixture of the smart noise and the channel noise integrated over time.

FIG. 12 is a snapshot of a pure smart noise integrated over time.

FIG. 13 is a snapshot of a mixture of the smart noise and the channel noise integrated over time.

FIG. 14 is a plot presenting results of BER tests for the communication system considered.

FIG. 15 is a plot presenting results of BER tests for the communication system considered.

FIG. 16 is a plot presenting the results of BER tests for the communication system considered.

FIG. 17 is a snapshot of the mixture of the smart noise and a decoy signal.

FIG. 18 is a view of the spectrum of the smart noise and the decoy signal.

FIG. 19 is a snapshot of the mixture of the smart noise and a decoy signal.

FIG. 20 is a view of the spectrum of the smart noise and the decoy signal.

For purposes of clarity and brevity, like elements and components will bear the same designations and numbering throughout the FIGURES.

### DESCRIPTION OF THE PREFERRED EMBODIMENT

This invention introduces a new approach to proprietary data transmission. The main idea of the stealth communication method proposed is not to hide a non-random information-bearing signal in a noisy background but rather using a special kind of an information-bearing noise. This smart noise is indistinguishable by its spectral properties from the noise in the communication channel. Yet, it has an internal structure that allows the intended recipient to successfully retrieve the proprietary message encoded in the noise. Moreover, such a smart noise (SN) can be combined with a decoy signal, the latter having a regular non-random structure and may be of a larger power than the SN. In this case an enemy or a competitor will be misled and will try to retrieve whatever information is encoded in the decoy signal. It will be shown that it is possible to design the structure of the SN in such a way that combining it with a much stronger decoy signal does not distort this structure and even enhances the retrieval properties of the SN.

1. Stealth Communication System

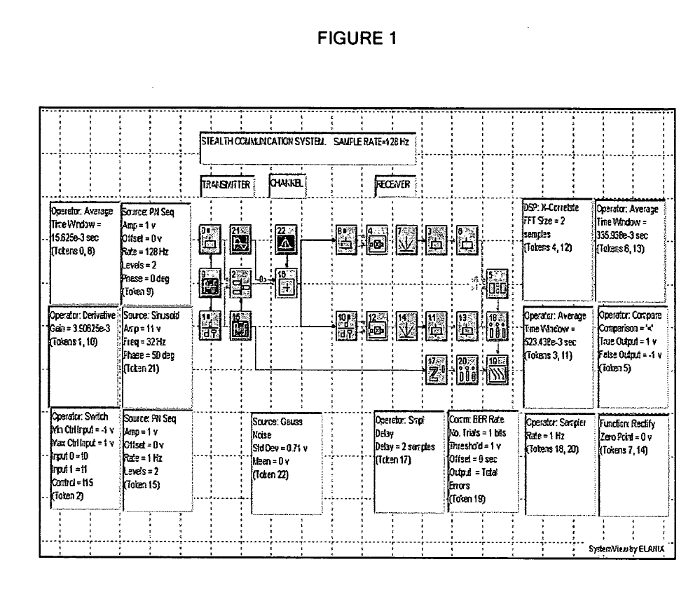

The proof of this concept is provided by means of using a numerical simulator. FIG. 1 presents an outline of the stealth communication system illustrating the method simulated in our study. The system consists of a transmitter, a channel, and a receiver. Transmission over a baseband AWGN channel sampled with the rate of 128 Hz was simulated.

The transmitter is represented by tokens 0, 1, 2, 9, 15, and 21. Token 9 represents a source of raw random data. In this case, it generates a PN sequence of the amplitude of 1 V at the rate of 128 Hz. The output of this token may be either +1 or −1. Generally, a subsystem represented by token 9 should generate a time series with statistical and spectral properties that are similar to those of the noise in the communication channel. This requirement is easy to satisfy if the channel noise can be represented by the noise sampled locally at the transmitter. Otherwise, one must be able to estimate some of the parameters of the channel noise at the receiver. The corresponding methods have been published (Mitlin, 2004). In the case of limited information about the channel, the minimum requirement of the time series is that its magnitude should be approximately on or below the level of the channel noise.

The time series generated by token 9 is separated into two random data streams. The first (token 0) is generated as follows:
output=(current input+input delayed by one sample)/2 (1)

The second (token 1) is generated as follows:
output=(current input−input delayed by one sample)/2 (2)

It follows from Eqs. (1) and (2) that operations performed by tokens 0 and 1 present the original time series as the sum of two other time series which, presuming that consecutive samples of the original time series are uncorrelated, provides that at least the first two statistical momenta are the same for these two time series.

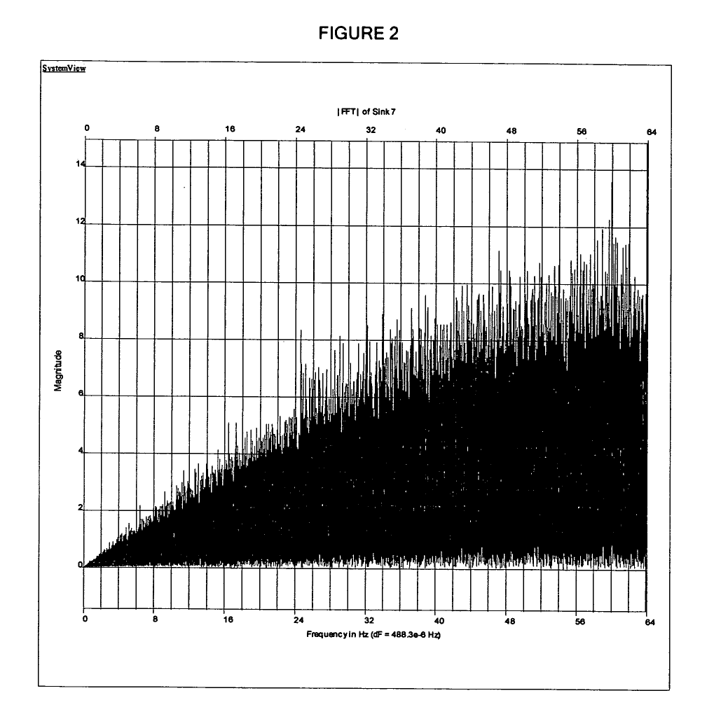

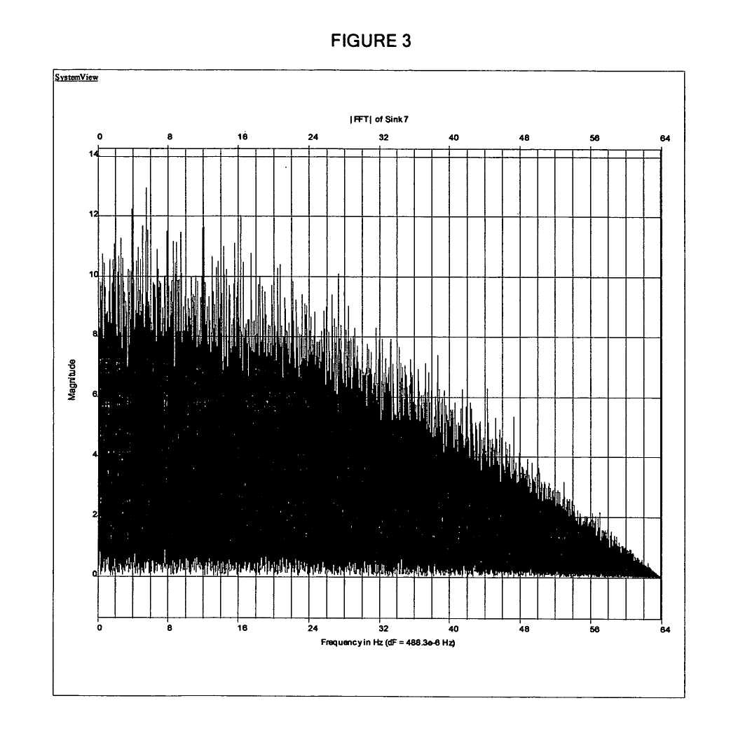

Other properties of these two time series, however, are different. The most noticeable difference is in their Fourier spectra. FIG. 2 shows the spectrum of the output of token 1. FIG. 3 shows the spectrum of the output of token 0. It is clear from looking at these spectra that token 0 and Eq. (1) describe a lowpass filter while token 1 and Eq. (2) describe a highpass filter.

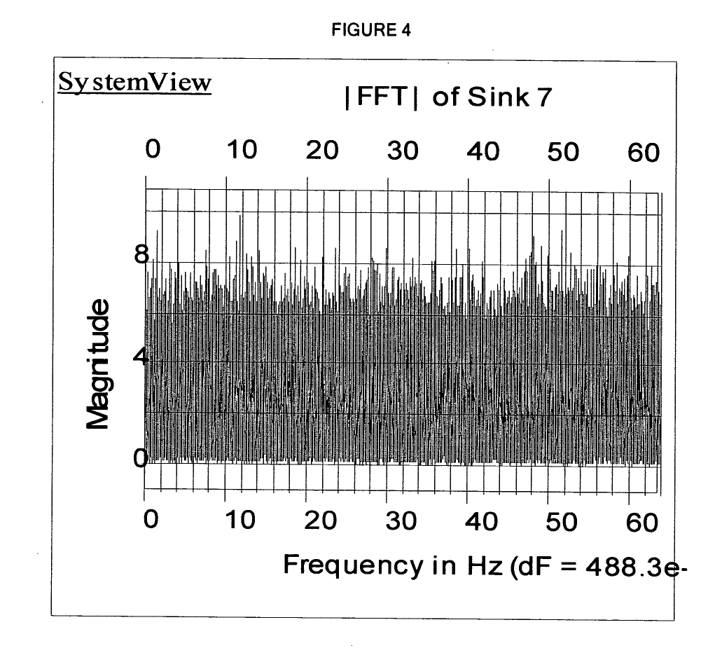

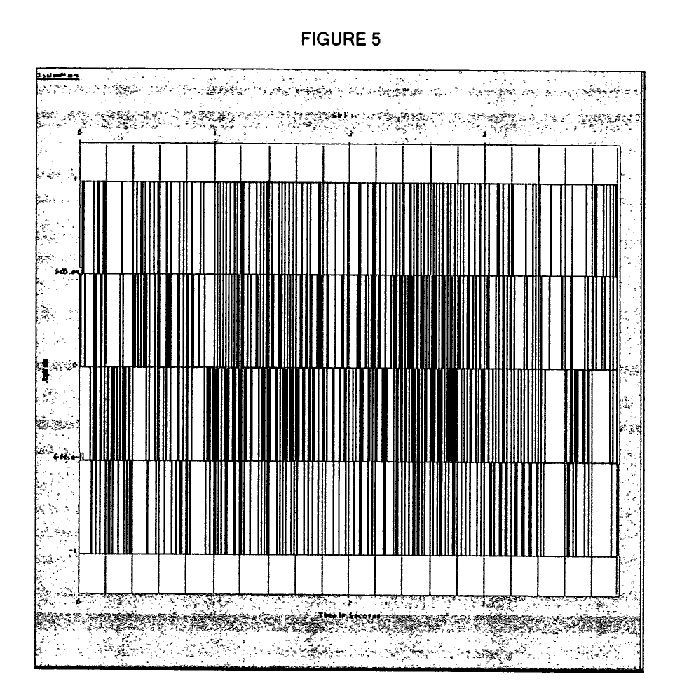

The random data streams generated by tokens 1 and 0 are components for further generation of the smart noise. They enter a switch (token 2) with two states controlled by the output of token 15. Token 15 represents a source of the proprietary message to be transmitted. In this case, it is a PN sequence with the amplitude of 1 V and two levels, +1 and −1. Symbols at the output of token 15 are generated at the rate of 1 Hz. Accordingly, the two internal states of switch 2 are +1 and −1. The output of switch 2 is a sequence of one-second long segments of the random data streams generated by tokens 0 and 1. A typical spectrum of this output is shown in FIG. 4. This spectrum is similar (i.e. exactly proportional with the proportionality coefficient of square root of 2) to that of the original time series generated by token 9, i.e. it is a typical white noise spectrum. However, this output has an internal structure mapped by the message generated by token 15.This is why one can regard it as a smart noise. A typical fragment of this output is shown in FIG. 5. Four consecutive segments are shown; a careful look reveals that there are two sparser and two denser data segments.

The final element of the transmitter relevant to our study is token 21. This token generates a decoy signal that conceivably could be added to the smart noise if an additional level of protection is needed for the message to be transmitted. We will discuss the details of operation, relevant to token 21, later in this document. It will be assumed for now that the decoy signal generator is turned off.

Depending on the specifics of the system, the transmitter may be complemented by a bandpass filter whose purpose is to shape the spectral window at the edges. Also, if the smart noise is generated by combining more than two random data streams, the latter may have to be passed through a bank of detrenders.

Next, the smart noise enters the channel and is distorted (or, shall we say, disguised) by the channel noise. In this study an AWGN channel is assumed.

Next, the mixture of the smart noise and the channel noise enters the receiver. There it is processed by two sequences of tokens (tokens 8, 4, 7, 3, 6 and tokens 10, 12, 14, 11, 13). Token 8 performs the same operation as token 0. Similarly, token 10 performs the same operation as token 1. Tokens 4 and 12 are cross-correlators with a window of 2. The outputs of these tokens, which are autocorrelation functions of the outputs from tokens 8 and 10, are then each processed by a rectifier (i.e. an absolute value is taken). The rectifier outputs are then each smoothed out by a sequence of two averagers. We found that the best performance of this system is attained as the sizes (in samples) of the windows of tokens 3, 11, 6, and 13 are mutually prime to the number of samples in one message symbol transmitted, i.e. 128. Specifically, the size of the window of tokens 3 and 11 was 67, and the size of the window of tokens 6 and 13 was 43. The outputs of tokens 6 and 13 enter the comparator (token 5). The output of the comparator is either +1 or −1 depending on the result of the comparison, and it represents the proprietary message retrieved at the receiver.

The performance of this stealth communication system was analyzed by comparing symbols of the transmitted and received messages in the BER token 19 after sampling these two messages at the rate of 1 Hz.

2. Test on Randomness

It was observed that transmitting the smart noise with a channel noise (CN) in the background may or may not be done in the stealth mode. Specifically, if the level of the SN is substantially higher than the level of the CN, then standard tests on randomness reveal an order in the structure of the mixture of SN and CN. However, at the SN-to-CN ratios (SNCNR) of the order of unity, the structure cannot be revealed. This is illustrated by the results of simulations described below.

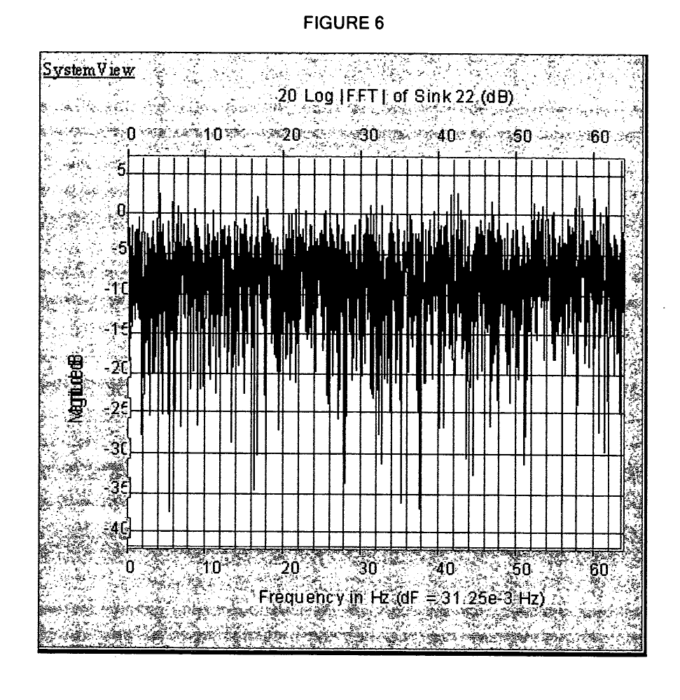

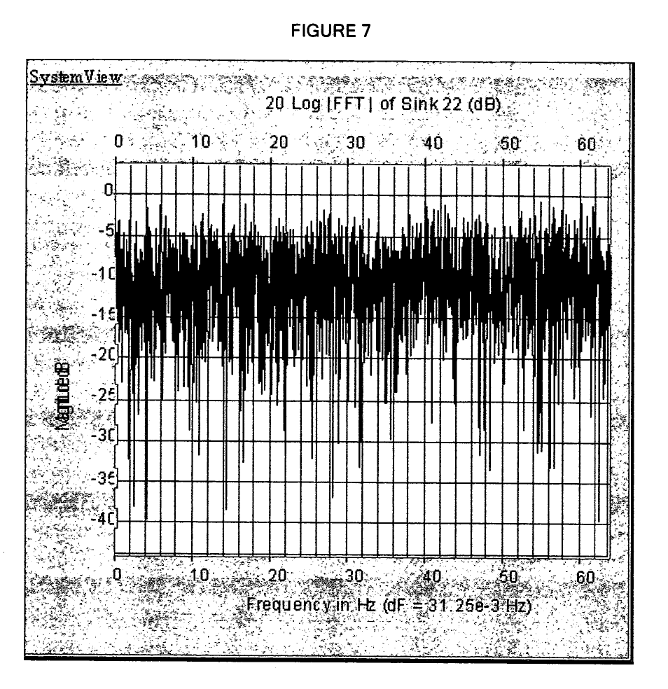

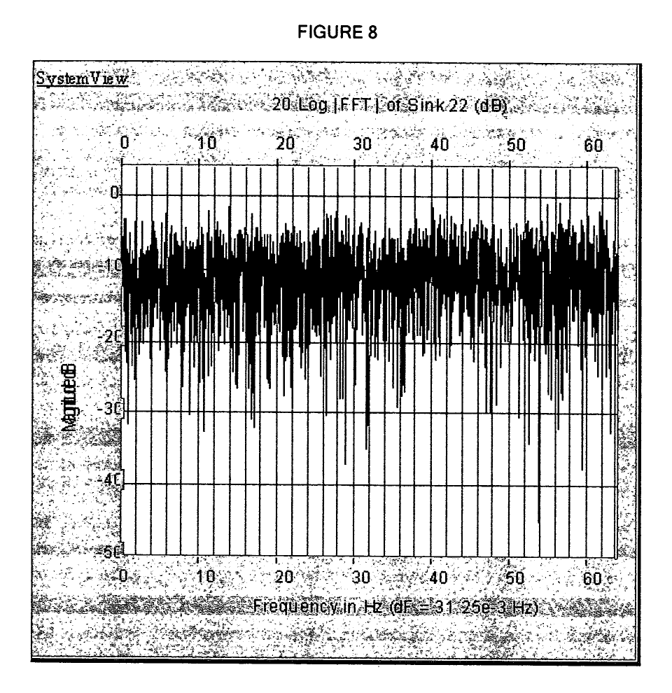

Fourier spectra of different mixtures of the SN and CN are shown in FIGS. 6 to 8. These spectra were computed using 4096 samples. FIG. 6 corresponds to the SNCNR value of 0 dB; FIG. 7—to 10 dB; and FIG. 8—to 20 dB. All these spectra look like that of white noise.

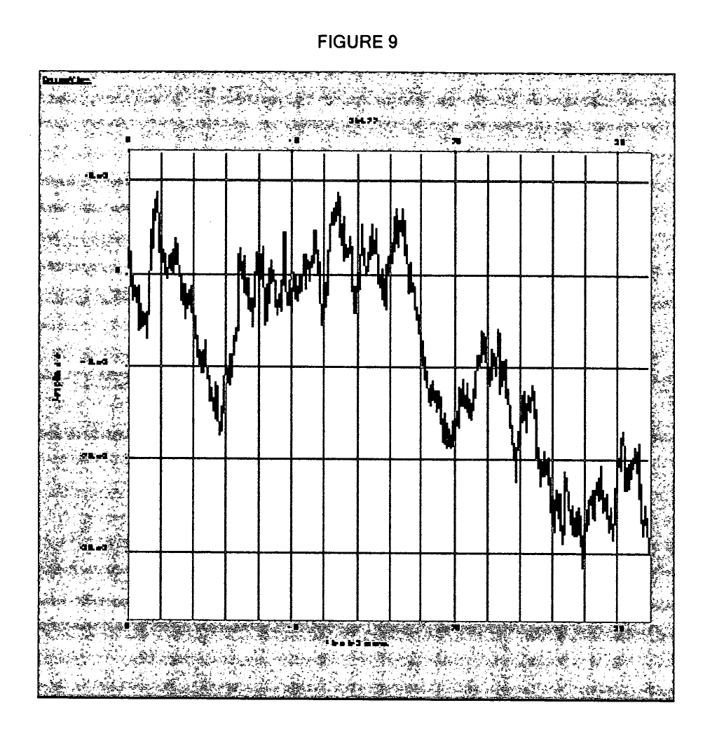

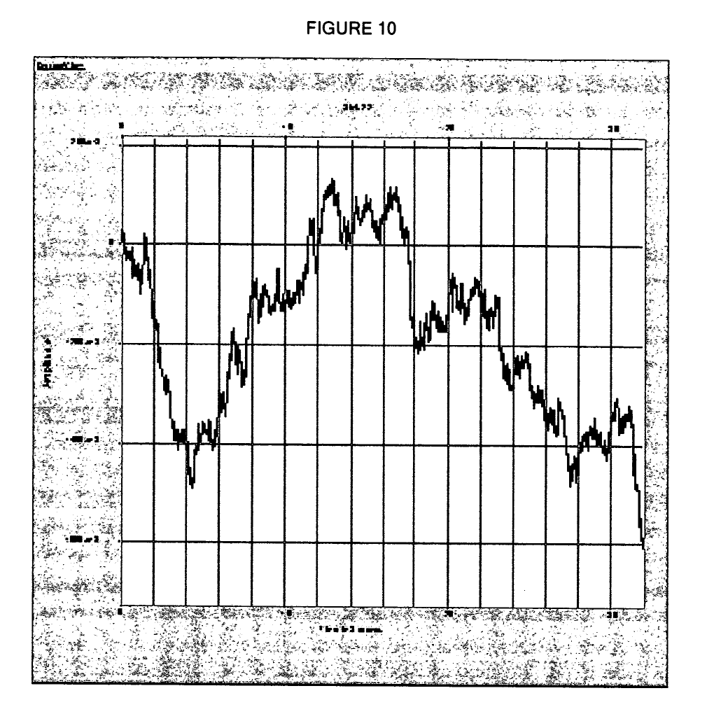

There are even more rigorous tests on randomness described below (Masters, 1995). FIG. 9 is a snapshot of the AWGN, with a mean square deviation of 0.71 V, integrated over time. FIG. 10 is a snapshot of the mixture of SN, with a mean square deviation of 0.71 V, and CN, with a mean square deviation of 0.71 V, integrated over time. The noise structures in both cases look similar.

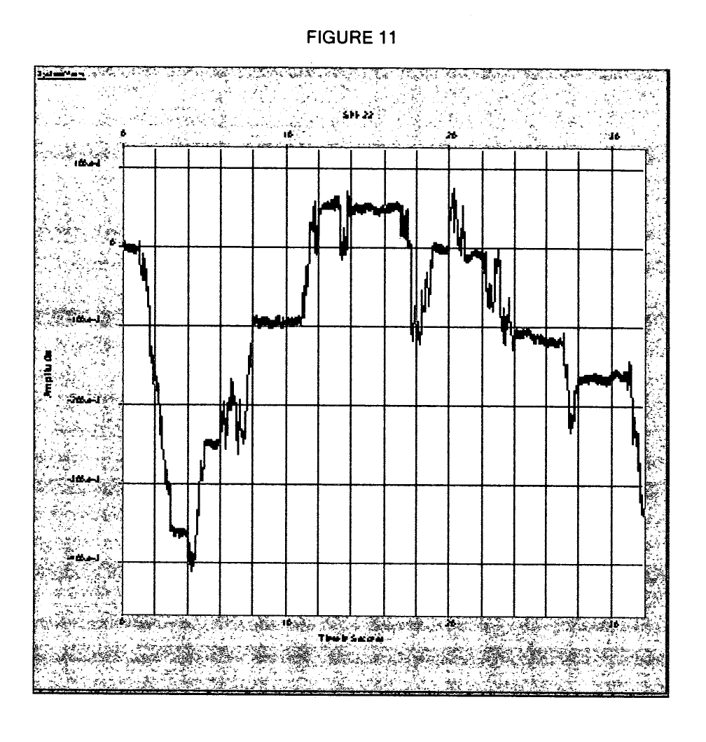

FIG. 11 is a snapshot of the mixture of SN, with a mean square deviation of 0.71 V, and CN, with a mean square deviation of 0.071 V, integrated over time. Comparing FIGS. 11 and 9 reveals an ordered structure of the smart noise. Plateau intervals of the duration of approximately one second correspond to transmitting the sparse component of the SN while steep ascends and descends between them correspond to transmitting the dense component of the SN. On the contrary, the AWGN structure does not contain such plateaus.

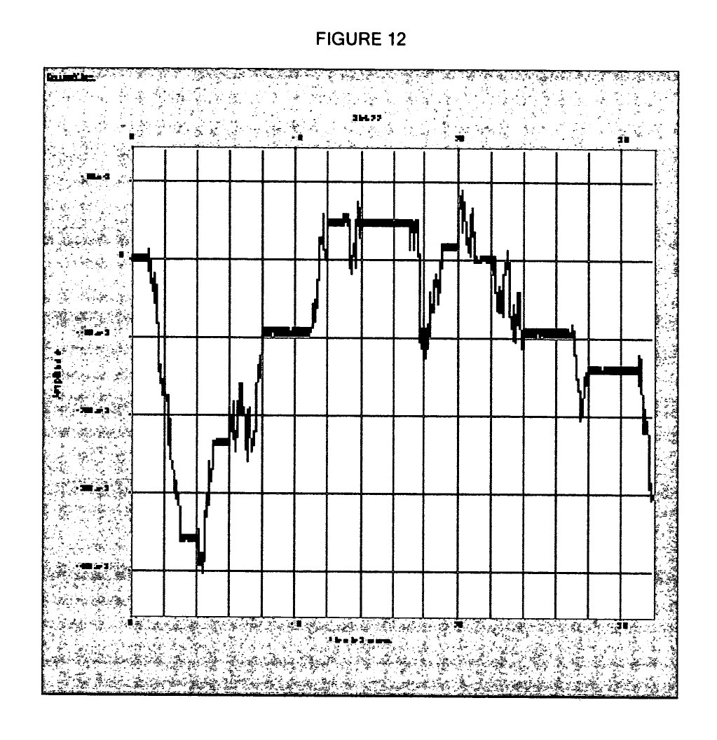

FIG. 12 is a snapshot of the pure SN, with the mean square deviation of 0.71V, integrated over time. One can see even more ordering than in the previous case considered.

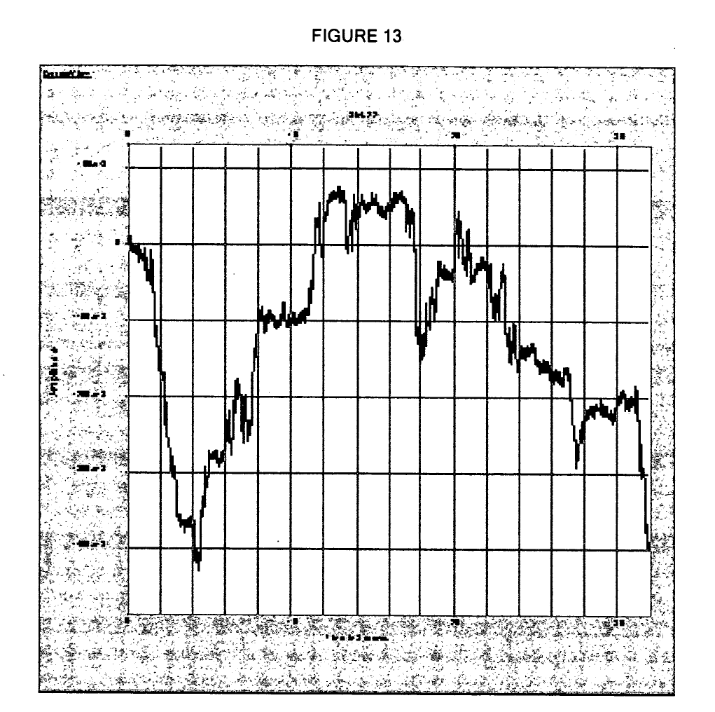

A borderline value of the SNCNR separating the situations where the structure of the SN with the CN in the background can and can not be revealed is about 10 dB. This is shown in FIG. 13 which is a snapshot of the mixture of SN, with a mean square deviation of 0.71 V, and CN, with a mean square deviation of 0.222 V, integrated over time.

3. BER Performance

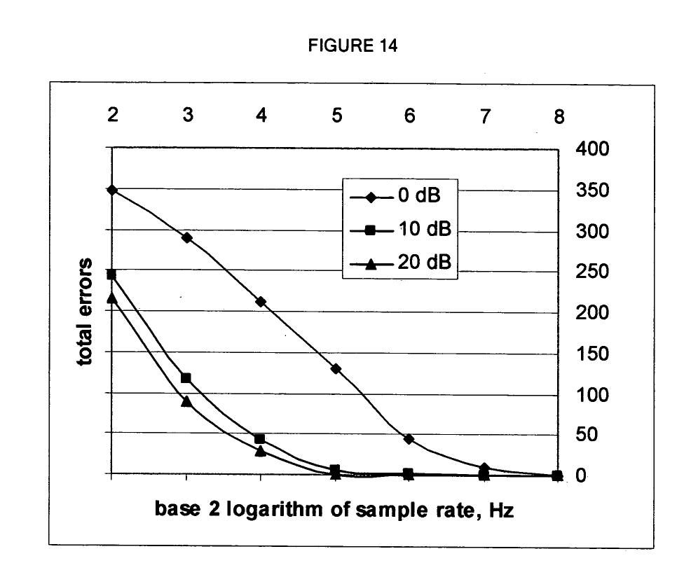

We conducted a series of simulations to evaluate the performance of the stealth communication system described. FIG. 14 presents results of several BER tests at different sample rates. It shows the total number of symbols in error versus the parameter n, where the sample rate was determined as 2\hat{ }n. The source of the raw noise for generating the SN is a PN sequence with the amplitude of 1 V and the rate of 2\hat{ }n. The message to be transmitted is a PN sequence with the amplitude of 1 V and a symbol rate of 1 Hz. Each data point in FIG. 14 was obtained by transmitting 1024 symbols. The sample rate considered ranged from 4 to 256 Hz. The BER performance improves as the sample rate increases. Specifically, at 128 Hz 10 errors were detected at 0 dB and no errors were detected at 10 and 20 dB. At 256 Hz no errors were detected in the entire range of SNCNR studied.

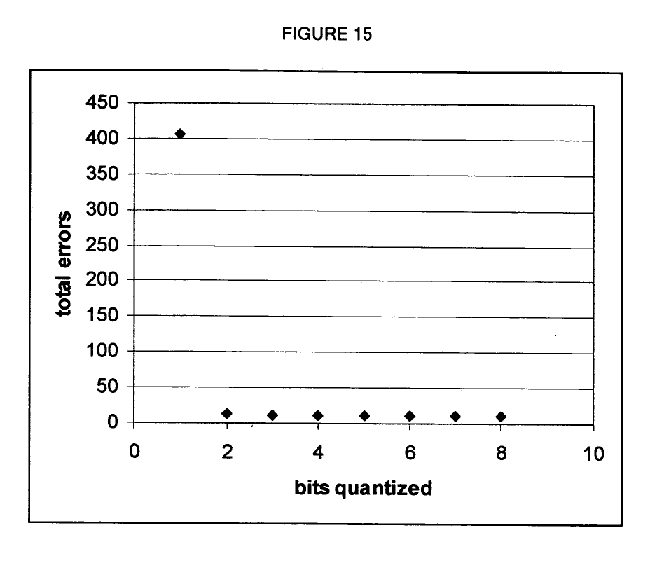

FIG. 15 illustrates the effect of quantization errors on the BER performance. In this set of simulations we used AWGN with a mean square deviation of 0.71 V as a channel noise. All other initial parameters are similar to the previous set of simulations. The system shown in FIG. 1 was modified by including a quantizer following the adder 16. The SN was quantized with a maximum input of ±2 V; FIG. 15 shows the total number of errors versus the number of bits quantized. The sufficient number of bits quantized equals 3, as retaining more than 3 bits does not change the BER performance.

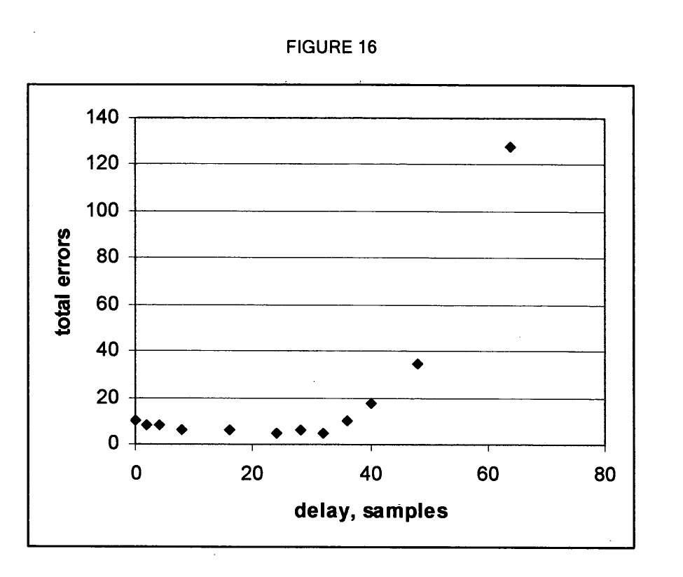

FIG. 16 describes the effect of a possible imprecision in detecting the arrival of the SN at the receiver. To study this effect the system shown in FIG. 1 was modified by introducing a sample delay following the comparator 5. FIG. 16 shows the total number of errors versus the delay in the arrival detection (in samples). The BER performance is about the same as the delay varies between 0 and 36 samples. This means that an imprecision in the arrival detection as large as a quarter of the duration of one message symbol can be tolerated

4. Using the Decoy Signal

A remarkable feature of this stealth communication system is that the SN can be complemented with a signal with a well defined, possibly periodical structure. This would be a decoy signal aimed to disguise the presence of the SN. Note that this approach is completely opposite to the traditional one where a lot of noise would be generated to disguise the presence of a non-random signal. Another remarkable feature of the method of adding the decoy signal to the SN is that it can be done not only without corrupting the SN but sometimes even enhancing the SN retrieval quality.

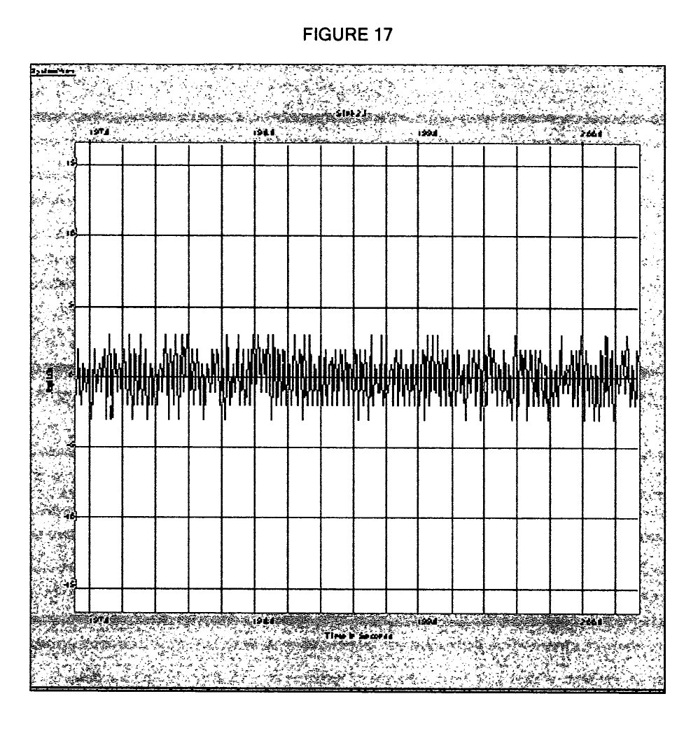

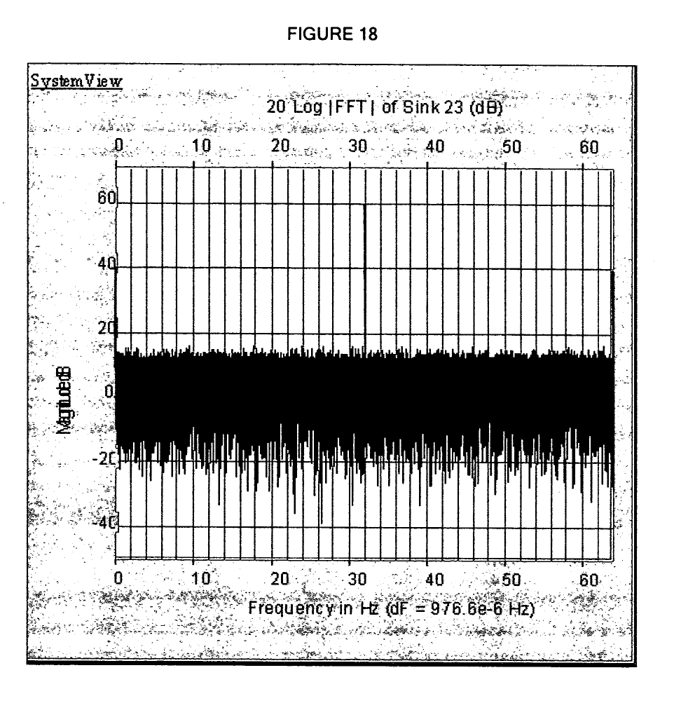

FIGS. 17 and 18 present the results of simulating the stealth communication system with the decoy signal feature. The system shown in FIG. 1 was modified by adding a source of a frequency sweep of the magnitude of 3 V, the frequency range swept of 28 to 36 Hz, and the period of 0.031 seconds. The channel noise was assumed to be very low, which in normal circumstances would be bad with respect to hiding the SN structure. However, as the magnitude of this decoy signal is substantially higher than the mean square deviation of the SN (0.71 V), variations in the decoy signal completely disguise the SN structure. It is also important to note that the preferred location of this decoy signal in the frequency spectrum is the central frequency of the spectral window used for transmission. It is well known that a possible inhomogeneity of the spectral density around the central frequency is considered a strong indication of the presence of an intelligent signal in the background noise (Masters, 1995). However, in the case of using the SN (here we specifically discuss a two-component SN) placing a narrow band decoy signal in the center of the spectral window does not corrupt the SN, since most of the energy carried by its components is localized in the lower half of the spectral window (for the sparse component) and in the higher half of the spectral window (for the dense component). As a result, there were no errors detected in transmitting the SN either with or without the decoy chirp signal. FIG. 17 presents a snapshot of the mixture of SN and the chirp. FIG. 18 presents the Fourier spectrum of this mixture. Looking at these figures, it seems obvious that someone tries to transmit a narrow band information bearing signal with a noise as a background. However, in fact ‘someone’ tries to transmit an information bearing noise with a non-random signal as a background.

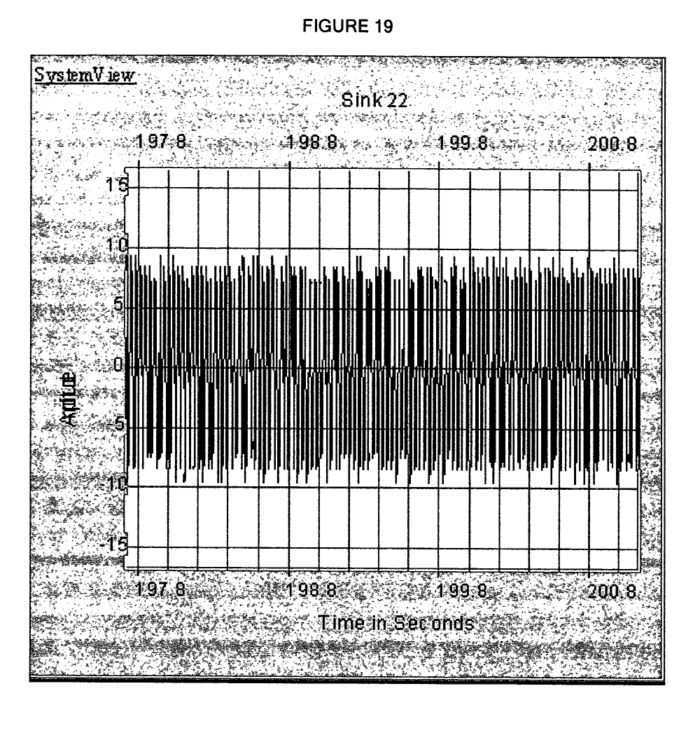

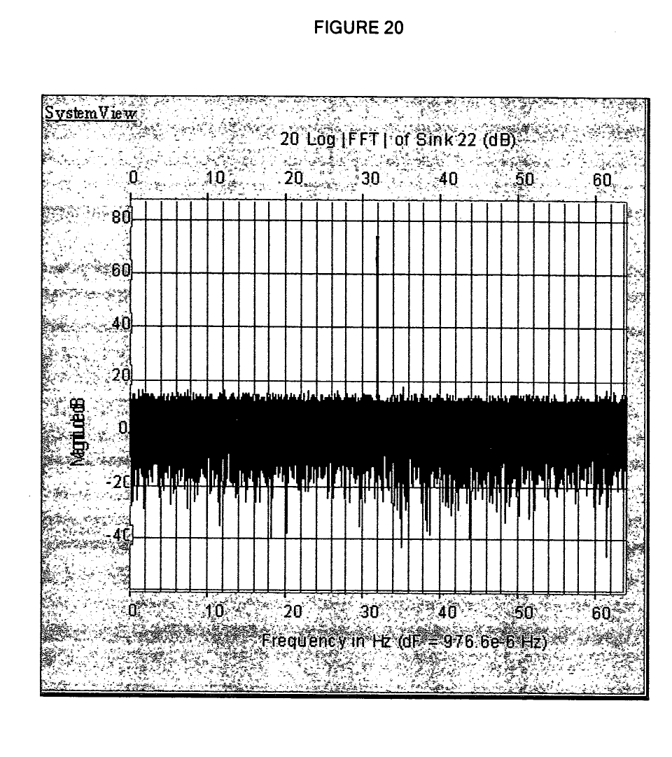

Even more outrageous simulation results are presented in FIGS. 19 and 20. In this case transmitting the SN and a sine wave as a decoy signal was simulated. The magnitude of the sine wave was 11 V, the frequency was 32 Hz, and the phase was 50 degrees. The snapshot of the mixture transmitted (FIG. 19) shows an almost periodical signal. The spectrum measured at the receiver is shown in FIG. 20. No errors were detected. Moreover, we performed simulations in the presence of a channel AWGN with a mean square deviation of 0.71 V, and the BER performance was actually better in the presence of the harmonic decoy signal than in its absence.

An important conclusion is that one can use the SN for stealth transmission even when the channel noise is low if a sufficiently large, properly designed decoy signal is used in conjunction with the SN.

5. References

Masters, Timothy; Neural and Hybrid Algorithms for Time Series Prediction, Wiley, New York, 1995
Mitlin, Vlad; Method of Determining the Quality of a Communication Channel, U.S. Patent Application, submitted Mar. 5, 2004
Proakis, John G.; Digital Communications, McGraw Hill, New York, 1995

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

1. A method for proprietary data transmission comprising:
means for transmitting a message over a communication channel between a transmitting station and a receiving station using a smart noise;
wherein said smart noise has an internal structure associated with said message.

2. The method of claim 1 wherein said means comprises:
generating at least two components of said smart noise at said transmitting station;
merging said components into the smart noise at the transmitting station; and
retrieving said message from the smart noise at said receiving station.

3. The method of claim 2, further comprising:
measuring the spectrum of the channel noise.

4. The method of claim 2, further comprising:
measuring an average power of the channel noise;
wherein said channel noise is an additive white noise characterized by said power.

5. The method of claim 2 wherein said generating comprises:
employing a time series having a similar spectrum as that of the channel noise;
determining current values of said components by applying predefined functions to said time series; and
said functions comprise an equality of at least two first statistical momenta of said components.

6. The method of claim 2, further comprising a similarity of the spectra of said smart noise and of the channel noise.

7. The method of claim 6 wherein said similarity is proportionality with a predefined coefficient.

8. The method of claim 5 wherein said functions are determined as follows:
output=(current input+input delayed by one sample)/2 and
output=(current input−input delayed by one sample)/2.

9. The method of claim 2 wherein said merging comprises:
extracting blocks of data of a predefined length, each from one said component at a time;
the order of switching between the components is determined by a current symbol in said message; and
said smart noise is a sequence of blocks of data extracted.

10. The method of claim 2 wherein said retrieving comprises:
applying a set of filters to said smart noise; and
each of said filters is associated to one of said components.

11. The method of claim 10 wherein said filters are the functions determined in accordance with claim 8.

12. The method of claim 11, further comprising:
applying a correlator to the output of each of said filters.

13. The method of claim 12, further comprising:
applying at least one averager to the output of each of said correlators;
wherein the number of samples in the window of said averager and the number of samples in one symbol of said message are mutually prime.

14. The method of claim 2, further comprising:
generating at least one decoy signal; and
complementing said smart noise with said decoy signal.

15. The method of claim 14 wherein the spectrum of the channel noise is noticeably different from that of said smart noise complemented with said decoy signal.

16. The method of claim 14, further comprising:
choosing the frequency of said decoy signal.

17. The method of claim 16 wherein said smart noise consists of two components; and
said frequency is the central frequency of the spectral window used for transmission.

18. The method of claim 16 wherein said smart noise consists of a plurality of components;
spectra of said components are predominantly localized in adjacent sections of the spectral window used for transmission; and
said frequency is at the boundary of two said adjacent sections of said spectral window.
